(19) United States
(12) Patent Application Publication
(10) Pub. No.: US 2007/0162964 A1
(43) Pub. Date: Jul. 12, 2007

(54) EMBEDDED SYSTEM INSURING SECURITY AND INTEGRITY, AND METHOD OF INCREASING SECURITY THEREOF

(76) Inventors: Liang-Yun Wang, Taipei City (TW); Li-Lien Lin, Hsinchu City (TW); Ming-Yang Chao, Hsin-Chu Hsien (TW); Ping-Sheng Chen, Chiayi County (TW); Ying-Che Hung, Taipei Hsien (TW); Chien-Hsun Tung, Tai-Chung City (TW); Yao-Dun Chang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/621,574

(22) Filed: Jan. 10, 2007

Related U.S. Application Data
(60) Provisional application No. 60/743,126, filed on Jan. 12, 2006.
(60) Provisional application No. 60/766,772, filed on Feb. 10, 2006.

(51) Int. Cl. H04L 9/32

(52) U.S. Cl. 726/5

(57) ABSTRACT

A system containing both software and hardware to perform secure operations especially suited for Digital Right Management. The system has hardware to accelerate Elliptic Curve calculations, hash algorithms, and various encryption algorithms. The system runs on encrypted software, and the software is checked for integrity before it boots.

### CROSS REFERENCE TO RELATED APPLICATIONS

This application claims all rights of priority of U.S. Provisional application 60/743,126 filed on Jan. 12, 2006 and U.S. Provisional application 60/766,772 filed on Feb. 10, 2006, both of which are incorporated herein in their respective entireties by reference.

### BACKGROUND OF THE INVENTION

1. Field of the Invention

This application relates to embedded systems, and more particularly, to an embedded system insuring security and integrity of firmware and setting therein, and a method of increasing security thereof.

2. Description of the Prior Art

The security of embedded systems has been increasingly important as these devices of the embedded systems manage valuable digital contents or sensitive personal data. Single chip systems are relatively easier to be built secure, like Smart Cards. General embedded systems with discrete DRAM or FLASH ROM chips face more challenges when they have to meet various robustness requirements.

Recent Digital Right Management protocols, e.g. Advanced Access Content Systems or Video Content Protection Systems, require data storage devices, as well as host software, to provide various cryptography functions while meeting strict robustness rules. The system must authenticate with the host software using a device-specific id and a matching secret key. The system also has to follow specific rules in processing sensitive data. The firmware stored in a discrete FLASH ROM may be altered to leak sensitive information, thus may have to be checked for authenticity or integrity.

In this disclosure, the invention describes architecture to handle these kinds of requirements with a typical embedded system.

### SUMMARY OF THE INVENTION

An embedded system includes an Application-Specific Integrated Circuit (ASIC), which includes a microcontroller unit, an on-chip memory unit coupled to the microcontroller unit, and an on-chip permanent storage coupled to the microcontroller unit storing a key data utilized by the microcontroller unit to uniquely identify the ASIC to an off-chip device.

The embedded system may further include a Hash-based Message Authentication Code (HMAC) module coupled to the microcontroller unit and to the on-chip permanent storage for loading a first key data from the on-chip permanent storage and utilizing the first key data to verify integrity of off-chip firmware. A selection of keys used in the firmware integrity check and firmware encryption stored in the on-chip permanent storage may be utilized by the HMAC module to restrict access to the off-chip firmware to vender authorized users. Updated firmware may be integrity checked by the HMAC utilizing a first key data and only validated updated firmware is loaded into the Flash ROM for future use.

The ASIC may further comprise hardware functional blocks to accelerate Elliptic Curve operations, secure hash algorithms, and perform encryption algorithms and/or comprise an ICE/Probe interface coupled to the microcontroller unit and a Password acknowledge unit coupled to the microcontroller unit and to the on-chip permanent storage.

The ASIC may further comprise an Elliptic Curve Digital Signature Algorithm (ECDSA) module coupled to the microcontroller and to the on-chip permanent storage for ECDSA authentication utilizing a second key data for ECDSA authentication of data exchanges with un-trusted devices or over un-trusted communication channels.

The ASIC may further comprise an Advanced Encryption Stand (AES) module coupled to the microcontroller and to the on-chip permanent storage for data encryption and decryption using a third key data loaded from the on-chip permanent storage.

A method of increasing security of an embedded system when the embedded system comprises an ASIC that includes a microcontroller and an on-chip permanent storage comprises storing a key data in the on-chip permanent storage and utilizing the key data to uniquely identify the ASIC to an off-chip device.

The utilizing the key data to uniquely identify the ASIC to an off-chip device comprises utilizing the key data to verify integrity of off-chip firmware.

The utilizing the key data to uniquely identify the ASIC to an off-chip device comprises utilizing the key data to verify integrity of updated firmware before the updated firmware is utilized.

The utilizing the key data to uniquely identify the ASIC to an off-chip device comprises utilizing the key data for Advanced Access Content System authorization of data exchanges.

The utilizing the key data to uniquely identify the ASIC to an off-chip device comprises utilizing the key data for Advanced Encryption Standard encryption and decryption during data exchanges.

The utilizing the key data to uniquely identify the ASIC to an off-chip device comprises utilizing the key data for disabling debugging functionalities of the embedded system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The invention can be more fully understood by reading the subsequent detailed description and examples with references made to the accompanying drawings.

FIG. 1 is a block diagram of an embedded system according to a first embodiment of the present invention.

FIG. 2 is a functional block diagram of an embedded system according to a second embodiment of the present invention.

FIG. 3 is a functional block diagram of an embedded system as used during a normal firmware update, according to a third embodiment of the present invention.

FIG. 4 is a functional block diagram of an embedded system 400 as used during Elliptic Curve Digital Signature Algorithm (ECDSA) authentication, according to a fourth embodiment of the present invention.

FIG. 5 is a functional block diagram of an embedded system as used during Advanced Encryption Standard (AES) data exchanges, such as in a CE environment, according to a fifth embodiment of the present invention.

FIG. 6 is a functional block diagram of an embedded system as used for debugging, according to a sixth embodiment of the present invention.

### DETAILED DESCRIPTION

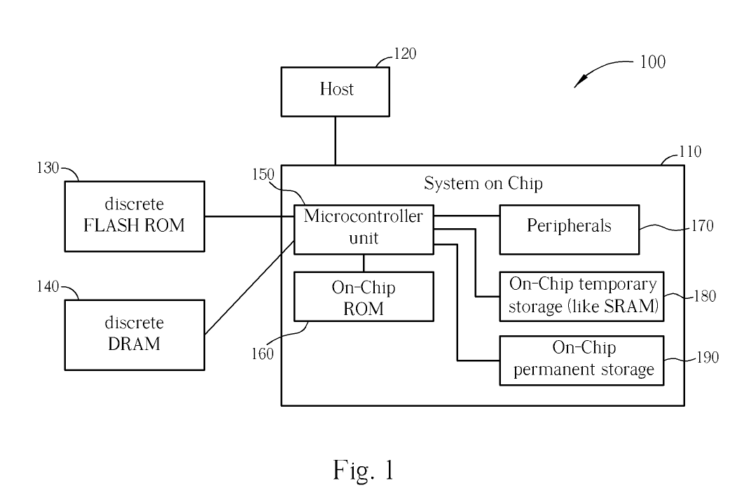

Please refer to FIG. 1, which is a block diagram of an embedded system 100 according to a first embodiment of the present invention. The embedded system 100 includes a System on Chip Application-Specific Integrated Circuit (ASIC) 110, a discrete FLASH ROM module 130, and a discrete DRAM module 140. The ASIC 110 includes a microcontroller unit (MCU) 150, an on-chip ROM 160, which may be a form of Flash Memory, on-chip peripheral units 170, an on-chip temporary storage 180, and an on-chip permanent storage 190. If the embedded system 100 is a data storage device, there would usually be a host 120 like a PC or MPEG side in consumer electronics (CE) player environment.

The microcontroller unit 150 is coupled via on-chip communication channels to the on-chip ROM 160, the on-chip peripheral units 170, the on-chip temporary storage 180, and the on-chip permanent storage 190, and is coupled via off-chip communication channels to the off-chip FLASH ROM module 130, and the off-chip discrete DRAM module 140. When the host 120 exists, the microcontroller unit 150 is also coupled via off-chip communication channels to the host 120. The discrete/insecure FLASH ROM 130, the discrete/insecure DRAM 140, and the host 120 are off-chip.

No off-chip communication channel can be considered safe as it can be easily eavesdropped by logic analyzers or similar tools. Even the discrete FLASH ROM 130 or the discrete DRAM 140 cannot be considered secure as it can be easily removed from the PCB and have its content dumped or modified. That is, the discrete FLASH ROM 130 can be taken as an insecure FLASH ROM, and the discrete DRAM 140 can be taken as an insecure DRAM.

With this in mind, the ASIC 110 includes the on-chip permanent storage 190 to hold an assortment of key data that are required for various security concerns. One example of the on-chip permanent storage 190 preferably is a one time programmable memory where once content has been written, the content cannot be changed, and will be referred to herein as an eFuse. An additional locking mechanism may be used to enforce a “write once” part of the eFuse 190. For security reasons, the content of the eFuse 190 would not be readable by firmware. The eFuse 190 can be programmed bit-by-bit. Part of the content in the eFuse 190 can be programmed during an IC manufacturing process, to minimize the risk of leaking ICs carrying unwanted functionality like ICE connectivity. Part of the content in the eFuse 190 can be programmed on the assembly line, especially the key data for secret keys. Part of the content in the eFuse 190 can be programmed after the device is assembled or even shipped to enable or disable some functionality, or to record special information like the Region Control Code. As an example, content of the eFuse 190 may include the key data indicating a key ID used in firmware integrity checks, a unique drive private key, keys used in communications with a host in a CE environment, a password and/or indications required for debugging the ASIC 110 purposes, a variety of OEM identification keys restricting an OEM to access of only firmware intended for their respective uses, and other secret system settings or keys.

The value or id of a key used for checking firmware integrity can be stored in the eFuse 190, so that all customers of the same ASIC 110 do not have to use the same secret key. If a complete key was stored in the eFuse 190, even a chip vendor would not know how to modify the firmware without being caught. Note that a drive-specific id or certificate can be usually stored in an external FLASH ROM 130, because key data for a matching drive-specific secret key is still stored inside the eFuse 190. The benefit of storing the matching drive-specific secret key on-chip, instead of in the FLASH ROM 130, is to guarantee a malicious hacker cannot change the drive-specific id or certificate without significant effort. The revocation mechanism of modern Digital Rights Management (DRM) systems requires each device to bear a unique certificate that is difficult to be changed.

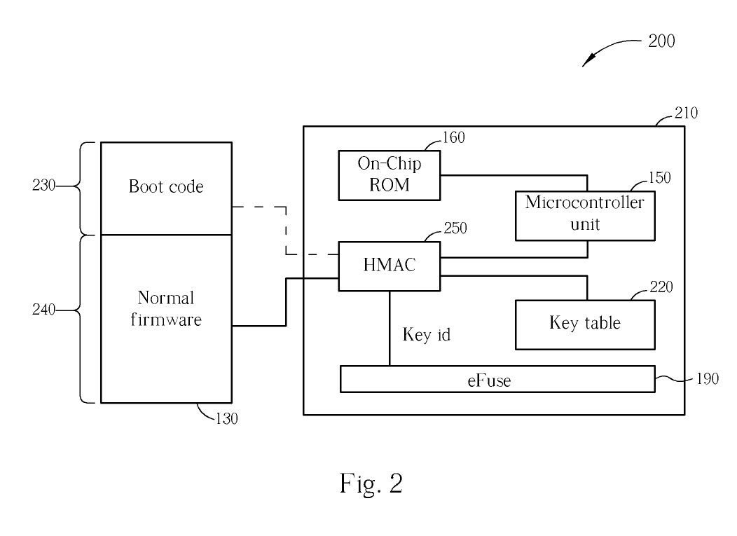

Please refer to FIG. 2, which is a functional block diagram of an embedded system 200 according to a second embodiment of the invention. The embedded system 200 includes all of the same components as the embedded system 100 even if omitted from FIG. 2 to focus attention on a boot operation for the embedded system 200. As shown in FIG. 2, an ASIC 210 includes a Hash-based Message Authentication Code (HMAC) module 250 and optionally a key table 220 according to design considerations.

The chip vendor embeds a block of on-chip ROM 160 to be executed before the embedded system 200 fetches any boot code 230 from the external discrete FLASH ROM 130 during the corresponding boot operation. The firmware stored in the on-chip ROM 160 loads the key data from the eFuse 190 into the HMAC module 250, and the HMAC module 250 checks the integrity of external codes or firmware. If the key data stored in the eFuse 190 is the entire secret key, the HMAC module 250 can use the retrieved secret key directly to validate the boot code 230 and/or the normal firmware 240. In another embodiment, the key data stored in the eFuse 190 is only a key ID and the HMAC module 250 uses the retrieved key ID to access the key table 220 to obtain the entire secret key before verifying the boot code 230 and/or the normal firmware 240.

To increase flexibility and performance, the on-chip ROM 160 may selectively check only part of the external codes or firmware at any given time. The remaining firmware image can be checked later before it is needed or when the system is idle. It is also possible to check the external codes or firmware in multiple chunks, so that the embedded system 200 can be responsive to external events before the whole firmware image has been validated. The algorithms used in the On-Chip ROM 160 and the external FLASH ROM 130 can be different, so that OEMs may choose a different strategy from an original design.

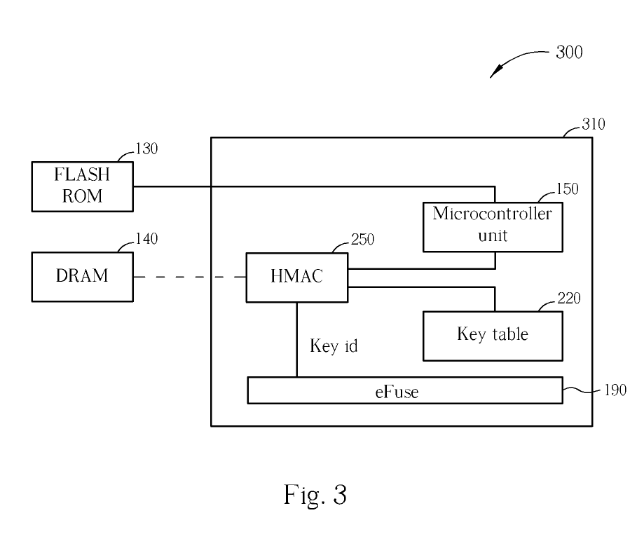

Please refer to FIG. 3, which is a functional block diagram of an embedded system 300 as used during a normal firmware update, according to a third embodiment of the invention. The embedded system 300 includes all of the same components as the embedded system 100 even if omitted from FIG. 3 to focus attention on a normal firmware update operation for the embedded system 300. As shown in FIG. 3, an ASIC 310 includes the Hash-based Message Authentication Code (HMAC) module 250 and optionally the key table 220 according to design considerations.

During a normal firmware update, the embedded system 300 is controlled by execution of firmware from a normal memory device 140, such as DRAM, which receives the firmware update from a host preferably via a normal advanced technology attachment packet interface (ATAPI) command. The embedded system 300 first checks integrity of a new firmware image corresponding to the firmware update, and then stores the updated firmware into the FLASH ROM 130. The HMAC module 250 checks the integrity of the firmware update by utilizing key data loaded from the eFuse 190, either by loading the needed secret key directly from the eFuse 190 or by loading a key ID from the eFuse 190 and utilizing the retrieved key ID to obtain the required secret key from the key table 220. Once the HMAC module 250 has validated the firmware update, the embedded system 300 then stores the firmware update into the FLASH ROM 130.

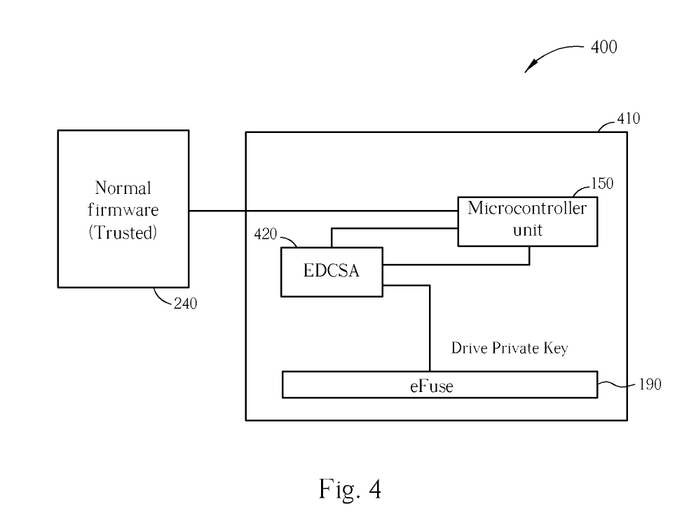

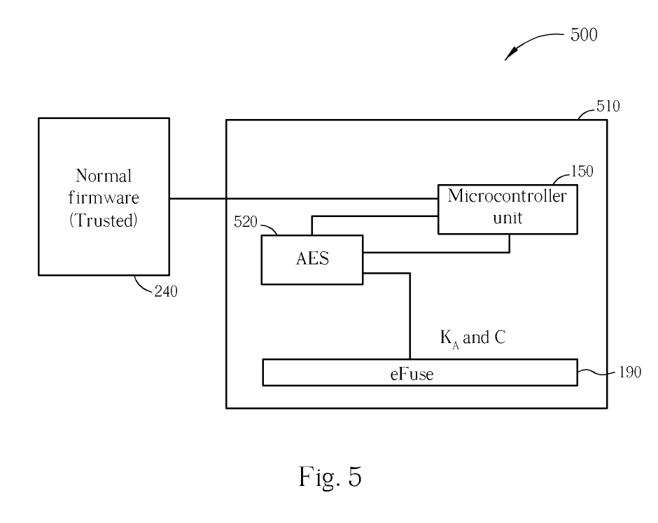

Please refer to FIG. 4 and FIG. 5. During Advanced Access Content System (AACS) authentication or other kinds of key management operations, the exemplary embedded system may load a device-specific key, meaning a guaranteed unique key that has been associated with the specific device, from the eFuse 190. The drive's private key may be 160 bits in size. The key data stored in the eFuse 190 is preferred to be not directly accessed by the firmware, but only loaded and used by hardware of the embedded system in various protocols. Consequently, even the firmware may be exposed to hackers, but the hardware behavior is still kept secret.

FIG. 4 is a functional block diagram of an embedded system 400 as used during Elliptic Curve Digital Signature Algorithm (ECDSA) authentication, according to a fourth embodiment of the invention. The system 400 includes all of the same components as the embedded system 100 even if omitted from FIG. 4 to focus attention on ECDSA authentication. As shown in FIG. 4, an ASIC 410 includes an ECDSA module 420 and optionally the key table 220 according to design considerations. Key data is loaded from the eFuse 190 into the ECDSA module 420. The key data may be a drive's private key, or a key ID which is utilized to obtain the drive's private key from the key table 220. The ECDSA module 420 utilizes the key data for ECDSA authentication of data exchanges with un-trusted devices (for example the host 120) or over un-trusted communication channels (for example the data channel coupling the host 120 to the ASIC 410).

FIG. 5 is a functional block diagram of an embedded system 500 as used during Advanced Encryption Standard (AES) data exchanges, such as in a CE environment, according to a fifth embodiment of the invention. The AES handles encryption, decryption, and both cipher block chaining (CBC) and electronic code block (ECB) modes are commonly used. The embedded system 500 includes all of the same components as the embedded system 100 even if omitted from FIG. 5 to focus attention on AES data exchanges. As shown in FIG. 5, an ASIC 510 includes an AES module 520 and optionally the key table 220 according to design considerations. Similarly, key data is loaded from the eFuse 190 into the AES module 520. In this embodiment, the key data may be 256-bit K_{A} and C secret keys. The AES module 520 utilizes the key data for AES authentication of data exchanges during encryption and decryption of data.

In at least one embodiment, the ECDSA module 420 and the AES module 520 are coupled on a same ASIC, such as the ASIC 110, enabling sharing of resources between the ECDSA module 420 and the AES module 520, especially hardware registers and control arithmetic units.

The exemplary embedded system may selectively implement several most useful components in appropriately coupled hardware blocks to accelerate various operations in AACS and other common secure-related protocols.

One exemplary hardware block can be an AES block, which handles encryption, decryption, where both CBC and ECB modes are commonly used. The AACS also can use the AES block in the CMAC (Cipher-based Message Authentication Code) mode.

Another exemplary hardware block can be an SHA-1 block, which can be used in the ECDSA and HMAC operations. The AACS requires SHA-1 capability to verify data of significant size. Direct Memory Access function to transfer data from DRAM or FLASH ROM to the SHA-1 buffer memory might be necessary to achieve target data rate.

Another exemplary hardware block can be an Elliptic Curve block. The most time-consuming operation is scalar multiplication and addition of points on the elliptic curve. Other related operations include very long integer arithmetic performed in normal or Montgomery domain.

All these hardware blocks can share most resources like SRAM and an Arithmetic Logical Unit (ALU). These algorithms all can be implemented using a 32-bit ALU properly programmed by hardware state machines and a small amount of DRAM or SRAM. These functions can be also written as firmware and executed in the general purpose MCU 150, but the overhead to explicitly fetch instructions and data are so large that the performance usually is not satisfactory. The performance for SHA-1 and EC operations on an 8 or 16-bit MCU 150 would be almost prohibitive.

Note that, the firmware, especially the firmware used in cryptography calculations, can be encrypted or scrambled before it is burned into the external FLASH ROM 130. The encrypted firmware image further protects the secrecy of this system. Firmware image of the common MCU 150 can be easily disassembled, but even slightly scrambled firmware could be much more difficult to understand. It is especially important when the algorithm of data processing must be kept secret like several data fields on AACS protected discs. The actual algorithm used to scramble or encrypt the firmware depends upon the implementation.

The value or id of a key used in firmware encryption can be stored in the eFuse 190, so that all customers of the same SoC do not have to use the same secret key. If the complete key is stored in the eFuse 190, even the chip vendor would not know how to build a workable firmware image.

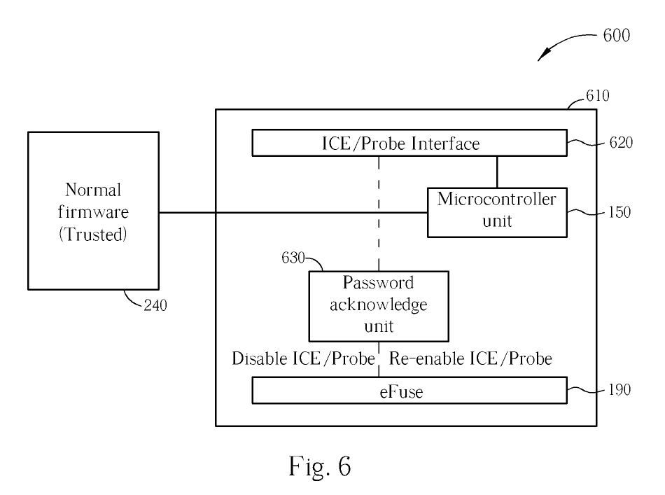

Please now refer to FIG. 6, which is a functional block diagram of an embedded system 600 as used for debugging, according to a sixth embodiment of the invention. The embedded system 600 includes all of the same components as the embedded system 100 even if omitted from FIG. 6 to focus attention on privatizing debugging methods. As shown in FIG. 6, an ASIC 610 also includes an ICE/Probe Interface 620 coupled to the MCU 150 and a Password acknowledge unit 630, which are in turn couple to the eFuse 190.

Various debug functions can be used to probe how the firmware works or how the internal system states, thus it is dangerous to the security of this system. The on-chip permanent storage can be also used to turn on or off these function blocks to maximize flexibility and security. The debug function can be default on but permanently turned off in manufacturing process. Only a small number of Engineering Samples can be used for firmware development.

A simple way to control access to debugging procedures is to reserve a small section of the eFuse 190 for this purpose. For example, a single first bit at a secret location within the OTM eFuse 190 can be initially programmed as a 1. When debugging is desired, a user enters a password, and the Password acknowledge unit 630 loads the key data, in this case the first bit, and validates both the password and that the first bit is set to a 1. When debugging is completed, reprogramming the first bit to be set to a 0 prevents further debugging access.

Additionally, it is possible to reserve a second single bit also within a secret location of the eFuse 190 that is originally programmed as a 1. If a manufacturer wishes to perform further debugging on the ASIC after the first bit has been reprogrammed to be a 0 (for example if a chip is return by a customer as faulty), the second bit may be reprogrammed to be a 0. If the Password acknowledge unit 630 loads the key data, in this case the second bit, and validates both the password and the second bit being set to a 0, debugging methods become available again. The single bits within the eFuse 190 permitting debugging procedures and prohibiting further debugging procedures help to prevent unauthorized individuals from gaining knowledge of the internal workings of the ASIC while permitting the manufacturer normal testing procedures. It should be noted that the use of a user-entered password to gain debugging access is preferred, but other embodiments only require the Password acknowledge unit 630 to validate the correct value of the first and/or second bit.

The teachings of the present invention are exemplarily directed towards the secrecy of keys used in AACS, the secrecy of ROM-Mark and B9MID Algorithms, the integrity of firmware, the relationship to debug functions, and encrypted communications with the back-end in a CE environment. Major concern is also secrecy and integrity of various internal items, resistance to common debug tools like an EEPROM reader, Logic Analyzer, ICE, soldering iron, etc., and the association of a Device Key to a unique device. With this in mind, the various embodiments depictured in the drawings should not be considered in isolation, but any and all combinations of the ASIC 100 with an HMAC module 250 as described, a key table 220 as described, an ECDSA module 420 as described, and/or a Password Acknowledge Unit 630 as described should be considered within the bounds of the invention.

In conclusion, the embedded system of the present invention follows the AACS Robustness Compliance Rule by forming a compromise between hardware complexity and extra security requests. The unique Drive Private Key is stored in the On-Chip permanent storage (eFuse) preventing easy access and firmware can be integrity checked both at boot and during any update or download of data. The time spent on integrity checking is traded for enhance security and can be reduced by utilizing SHA-1 round numbers and integrity checking random sample from the firmware image until time permits a check of the complete image.

In addition, corresponding to embodiments of the embedded system, the invention also provides corresponding methods of increasing security of the embedded system. Each method includes storing a corresponding key data into the eFuse 190, and then utilizing the corresponding key data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An embedded system comprising:
an Application-Specific Integrated Circuit (ASIC) comprising:
a microcontroller unit; and
an on-chip permanent storage coupled to the microcontroller unit and storing a key data utilized by the microcontroller unit to uniquely identify the ASIC to an off-chip device.

2. The embedded system of claim 1, further comprising a Hash-based Message Authentication Code (HMAC) module coupled to the microcontroller unit and to the on-chip permanent storage for loading a first key data from the on-chip permanent storage and utilizing the first key data to verify integrity of off-chip firmware.

3. The embedded system of claim 2, wherein the off-chip firmware is stored in a Flash ROM.

4. The embedded system of claim 3, further comprising an on-chip memory unit coupling to the microcontroller unit for storing a ROM code that when executed by the microcontroller unit causes the HMAC module to load the first key data and utilize the first key data to verify integrity of off-chip boot code in the Flash ROM.

5. The embedded system of claim 4, wherein the first key data is an entire secret key, the HMAC module uses the first key data directly to validate the off-chip firmware or the off-chip boot code.

6. The embedded system of claim 4, wherein the first key data is a key ID, the HMAC module utilizing the first key data to access an on-chip key table to obtain an entire secret key to verify integrity of the off-chip firmware or the off-chip code.

7. The embedded system of claim 3, wherein the firmware integrity checking is separated into different phases executed at different times.

8. The embedded system of claim 3, wherein at least part of the off-chip firmware is encrypted or scrambled.

9. The embedded system of claim 8, wherein a selection of keys used in the firmware integrity check and firmware encryption stored in the on-chip permanent storage are utilized by the HMAC module to restrict access to the off-chip firmware to vender authorized users.

10. The embedded system of claim 8, wherein updated firmware is integrity checked by the HMAC utilizing the first key data and only after validation is the updated firmware loaded into the Flash ROM.

11. The embedded system of claim 2, wherein the ASIC further comprises hardware functional blocks to accelerate Elliptic Curve operations, secure hash algorithms, and perform encryption algorithms.

12. The embedded system of claim 1, further comprising an ICE/Probe interface coupled to the microcontroller unit and a password acknowledge unit coupled microcontroller unit and to the on-chip permanent storage.

13. The embedded system of claim 12, wherein the on-chip permanent storage further comprises at least a bit accessed by the password acknowledge unit that disables debugging functionalities of the embedded system.

14. The embedded system of claim 1, further comprising an Elliptic Curve Digital Signature Algorithm (ECDSA) module coupled to the microcontroller and to the on-chip permanent storage for ECDSA authentication.

15. The embedded system of claim 14, wherein a second key data is loaded from the on-chip permanent storage to the ECDSA module which utilizes the second key data for ECDSA authentication of data exchanges with un-trusted devices or over un-trusted communication channels.

16. The embedded system of claim 1, further comprising an Advanced Encryption Stand (AES) module coupled to the microcontroller and to the on-chip permanent storage for data encryption and decryption.

17. The embedded system of claim 16, wherein a third key data is loaded from the on-chip permanent storage to the AES module which utilizes the third key data for AES encryption and decryption of data.

18. The embedded system of claim 1, wherein the on-chip permanent storage is a one-time-programmable memory.

19. A method of increasing security of an embedded system, the embedded system comprising an ASIC comprising a microcontroller and a on-chip permanent storage, the method comprising:
storing a key data into the on-chip permanent storage; and
utilizing the key data to uniquely identify the ASIC to an off-chip device.

20. The method of claim 18, wherein utilizing the key data to uniquely identify the ASIC to an off-chip device comprises:
utilizing the key data to verify integrity of off-chip firmware.

21. The method of claim 18, wherein utilizing the key data to uniquely identify the ASIC to an off-chip device comprises:
utilizing the key data to verify integrity of updated firmware before the updated firmware is utilized.

22. The method of claim 18, wherein utilizing the key data to uniquely identify the ASIC to an off-chip device comprises:
utilizing the key data for Advanced Access Content System authorization of data exchanges.

23. The method of claim 18, wherein utilizing the key data to uniquely identify the ASIC to an off-chip device comprises:
utilizing the key data for Advanced Encryption Standard encryption and decryption during data exchanges.

24. The method of claim 18, wherein utilizing the key data to uniquely identify the ASIC to an off-chip device comprises:
utilizing the key data for disabling debugging functionalities of the embedded system.
